(19) United States
(12) Patent Application Publication
(10) Pub. No.: US 2026/0318700 A1
(43) Pub. Date: Oct. 15, 2026

(54) PERSPECTIVE-ALIGNED ENVIRONMENTAL GUIDANCE AND ORIENTATION CALIBRATION

(71) Applicant: GOOGLE LLC, Mountain View, CA (US)

(72) Inventors: Mar Gonzalez Franco, Seattle, WA (US); Mathias Noerhede Lystbaek, Harlev J (DK); Peter Kai-hua Tan, Menlo Park, CA (US); Haley Adams, San Jose, CA (US); Ranjith Kagathi Ananda, San Jose, CA (US); Luca Ballan, San Jose, CA (US); Qiuxuan Wu, Sunnyvale, CA (US)

(21) Appl. No.: 19/639,889

(22) Filed: Apr. 6, 2026

Related U.S. Application Data
(60) Provisional application No. 63/786,145, filed on Apr. 9, 2025.

(51) Int. Cl. G01C 21/36; G06T 7/73; G06V 10/44; G06V 20/50

(52) U.S. Cl. CPC G01C 21/3629; G06T 7/73; G06V 10/44; G06V 20/50; G06T 2207/30244

(57) ABSTRACT

A system and method for perspective-aligned environmental guidance and orientation calibration include receiving image data from an imaging device and feature profiles for a set of candidate features. A feature analysis module identifies a feature from the set within the image data based on a correspondence between the image data and a feature profile. An orientation computation module calculates an orientation of the imaging device by comparing a field of view of the image data to a location of the feature, resulting in a six-degree-of-freedom calibration. An instruction synthesis module provides a navigation action via an output device based on the orientation and a navigation path. The instruction synthesis module provides the navigation action via a spatial audio signal in response to a determination that the orientation has deviated from a target heading, resulting in a reduction of cognitive load and a persistent orientation calibration.

### CROSS-REFERENCE TO RELATED APPLICATION

This application claims priority to U.S. Provisional Patent Application No. 63/786,145, filed on Apr. 9, 2025, entitled “CONTEXTUAL AND AUDIO NAVIGATION”, the disclosure of which is incorporated by reference herein in its entirety.

### BACKGROUND

Wearable devices and mobile applications provide a framework for interacting with an environment through the synthesis of distributed data streams. Modern computing architectures employ imaging devices and geospatial databases to facilitate an alignment between a user and the environment. The computing systems analyze environmental context and directional parameters to generate navigation actions. Advances in sensor integration and data processing expand the capability of wearable devices to deliver the navigation actions during movement through a landscape.

### SUMMARY

Traditional navigation systems employ distance-based instructions to indicate a proximity to a destination. The distance-based instructions assume a precise estimation of distance during movement through an environment. A technical limitation of the traditional navigation systems is a failure to provide environmental grounding for the distance-based instructions. When a computing system provides an abstract measurement without a visual reference, the computing system lacks a framework for verifying a position, resulting in a loss of situational awareness relative to a navigation path.

The computing system provides a technical solution by substituting abstract distance measurements with verifiable environmental anchors. To implement this solution within a mobile context, the computing system identifies environmental features, such as a building or a landmark, within a field of view captured by an imaging device. The computing system generates navigation actions that relate a required movement to the environmental features. The matching of visual features to a feature profile results in an orientation calibration of the computing system within an egocentric coordinate frame anchored to the environment.

The computing system further provides directional guidance through spatial audio synthesis to maintain alignment with a navigation path. In response to a determination that a device orientation faces away from a target heading, the computing system generates a spatial audio signal. The spatial audio signal simulates a sound source originating from a direction of travel for the navigation path. The spatial audio signal provides a continuous auditory reference, allowing the computing system to guide movement without a visual display. The combination of environmental feature identification and spatial audio synthesis results in a navigation action that reduces cognitive load and provides persistent orientation calibration.

The computing system implements the technological solution through a specific sequence of technical operations. The computing system receives image data from an imaging device and retrieves a plurality of feature profiles for a set of candidate features. A feature analysis module determines the set of candidate features in response to a position of the imaging device. The feature analysis module then determines a correspondence between the image data and a feature profile of the plurality of feature profiles to determine a presence of a feature from the set of candidate features in the image data.

An orientation computation module calculates an orientation of the imaging device by comparing a field of view of the image data to a location of the feature. In response to the orientation and a navigation path, an instruction synthesis module provides a navigation action via an output device. The instruction synthesis module determines a difference between the orientation and a target heading of the navigation path and provides the navigation action based on the difference. Generating the navigation action based on the difference provides a technical framework that ensures that the navigation action is anchored to the environment.

The computing system refines the navigation action by assigning a distance value to the environmental feature. The feature analysis module determines the distance value based on a plurality of boundaries of the environmental feature within the image data. The instruction synthesis module includes the distance value within the navigation action, resulting in the provision of technical context for a turn. To identify the environmental feature, the feature analysis module assigns a confidence metric based on an attribute of the environmental feature. The attribute represents a permanence of the environmental feature, resulting in the selection of static landmarks for the orientation calibration.

In implementations where the imaging device is a component of a wearable device, the instruction synthesis module employs an audio transducer to provide the navigation action via a spatial audio signal. The spatial audio signal includes a sequence of instructions associated with the navigation path, where the sequence of instructions includes a turn direction and a reference to the feature in a sequential order. The spatialized output allows the computing system to deliver directional guidance that is mapped to an egocentric perspective of the wearable device.

The described systems and methods can include any combination of the described aspects and features. The systems and methods are not limited to the specific combinations set forth herein. Moreover, the accompanying drawings and the description below set forth the details of one or more implementations. Other features and advantages will be apparent from the description, drawings, and claims.

### BRIEF DESCRIPTION OF THE DRAWINGS

The accompanying drawings, which are incorporated in and constitute a part of the specification, illustrate implementations of the disclosure and, together with the description, explain the principles of the disclosure.

FIG. 1 is a diagram illustrating an example environment in which the system is implemented.

FIG. 2 is a diagram illustrating an example perspective of an imaging device for generating contextual navigation instructions.

FIG. 3 is a block diagram illustrating a system architecture for generating contextual navigation instructions.

FIG. 4 is a flowchart illustrating an example process for initializing a navigation path.

FIG. 5 is a flowchart illustrating an example process for providing a proactive contextual navigation action.

FIG. 6 is a block diagram illustrating an example computing system for proactive contextual navigation.

Like reference numbers may refer to like elements.

### DETAILED DESCRIPTION

The integration of geospatial navigation with mobile computing has established coordinate-based guidance as a primary data type for digital architectures. Modern systems routinely generate directional instructions to facilitate movement through an environment. As digital navigation becomes ubiquitous, the methodology for communicating spatial guidance to a user has technical implications for the fields of wearable computing and human-computer interaction. The reliance on digital guidance systems affects how users perceive spatial relationships and navigate complex urban landscapes. Consequently, the technical framework for delivering instructions has a direct impact on movement through diverse environments. The disclosure serves as a technical foundation for systems that prioritize environmental presence over abstract data consumption.

A technical problem with conventional systems is a structural failure to reconcile asynchronous sensor data streams within environments subject to signal interference. Existing architectures rely on satellite-based positioning and magnetic heading values, where the global positioning signals often suffer from multipath interference and signal reflection in urban canyons. In the environments subject to signal interference, the conventional systems report inaccurate coordinates and unstable heading values, resulting in a failure of the computing system to maintain a calibrated orientation. Furthermore, the conventional systems exhibit intensive computational load and excessive power consumption when attempting to resolve orientation through continuous pixel-dense image processing. The constant execution of visual odometry on general-purpose processors rapidly depletes battery resources in mobile hardware. Conventional architectures also lack a technical capability to convert cardinal navigation data into egocentric coordinate frames without significant latency, resulting in a temporal mismatch between the device pose and the provided instructions.

Conventional navigation systems rely on the delivery of turn-by-turn instructions that prioritize cardinal directions and abstract distance measurements. A technical limitation of the conventional navigation systems is the reliance on continuous interaction with a visual display. The continuous interaction creates an attention bottleneck and reduces situational awareness within an environment. Furthermore, the conventional navigation systems lack contextual feedback to reconcile a device position with the environment. When the conventional navigation systems operate in urban canyons or environments with dense architectural configurations, global positioning signals suffer from multipath interference and signal reflection.

In the urban canyons or the environments with the dense architectural configurations, the conventional navigation systems report coordinates that lack spatial alignment with the environment, resulting in directional instructions that do not correspond to the actual position of a user. Recent advancements in machine learning models, such as multimodal variants integrating visual and textual data, provide a technological framework for context-aware actions. The machine learning models enable descriptions of surroundings and interactions, resulting in a technical alternative to the use of cardinal directions. The technological framework transforms visual environmental data into semantic navigation cues, resulting in a persistent orientation calibration that remains independent of global positioning signal precision.

The pervasive use of turn-by-turn navigation applications in smartphones and vehicles facilitates reaching destinations. People rely on the technology to avoid disruptions along routes and as a guide through unfamiliar territory. However, a reliance on navigation systems can impact a perception of navigation ability. In essence, a continuous reliance on navigation systems can affect how an individual perceives environmental knowledge. However, an individual utilizes the navigation systems differently depending on environmental familiarity; for instance, experienced users can supplement existing spatial knowledge with features like time and traffic estimations. For navigation of humans, contextual feedback is used to reconcile a position with an environment.

The disclosed systems and methods provide a technological framework that alters a machine-based navigation process by implementing a multi-modal sensor fusion architecture. The technological framework provides a technical implementation of a computer-centric process that addresses the limitations of sensor-drift and signal degradation. The computing system implements a specific, ordered set of operations that modifies the internal logic of the computing system. Building on the multi-modal sensor fusion architecture, the computing system establishes a spatial relationship between the user and the environment using virtual anchors. In response to a determination that a distance satisfies a proximity threshold to a virtual anchor, the computing system triggers a discrete image capture event. The event-based trigger minimizes the power consumption associated with continuous camera operation. Furthermore, the computing system employs a vision language model to determine a geometric alignment between an imaging device and a verified environmental feature. The computing system transforms the geometric alignment into a spatial audio signal.

The ordered combination of operations constitutes a technological improvement over generic data processing because the sequence enables the delivery of landmark-anchored instructions that replace abstract distance cues. By reconciling visual environmental anchors with geospatial measurements, the computing system provides a verifiable reference for navigation, resulting in a reduction of sensor-drift errors and a decrease in the computational overhead required for maintaining an orientation. The computing system transforms raw sensor inputs into a semantic understanding of the environment, allowing the computing system to provide guidance that is environmentally grounded. The specific sequence of operations, when tightly integrated with the sensor hardware of a wearable device, enables the computing system to resolve orientation ambiguity, providing a functionality that allows a user to maintain alignment with a navigation path without relying on a visual display. The technological solution further addresses the challenge of non-linear routes, such as backtracking or dead-ends, by using the environmental feature to anchor directional cues regardless of a direction of approach, resulting in a persistent orientation calibration.

Implementing the ordered combination of operations involves specific technological components organized within a functional system architecture. To identify environmental context, the computing system executes neural network inference to analyze visual textures and geometric boundaries within the image data. To determine a precise orientation, the computing system reconciles measurements from sensors, such as a global positioning system receiver and an inertial measurement unit, with an identified position of the environmental feature. The reconciliation of visual and geospatial data results in a six-degree-of-freedom calibration of the wearable device. The calibration persists within the functional system architecture for a defined temporal duration, allowing the computing system to provide accurate guidance between image capture events. The selection of a spatial audio signal for providing the navigation action is tailored to the orientation of the user. For example, the computing system applies head-related transfer functions to simulate the acoustic effects of a sound source originating from a specific point in a three-dimensional space.

The spatial audio synthesis simulates the interaural time differences and interaural level differences associated with human ear topology, resulting in a directional cue that the user perceives as a physical location. In some implementations, the system maintains a suppression state to deliver guidance signals when a deviation from a target heading exceeds a threshold, resulting in reduced computational overhead and optimized battery performance. The processing of environmental data allows the navigation action to remain calibrated across diverse landscapes and varying levels of sensor precision.

As used herein, an environmental feature may refer to a detectable and verifiable element within an environment, such as a landmark, a building, a storefront, or a piece of infrastructure. The environmental feature may also be referred to herein as a first feature, a second feature, or a feature. The environmental feature serves as a static reference point for the calibration of a device orientation. A wearable device may refer to a mobile computing apparatus comprising a supporting housing and a power source configured to be physically worn by a user to capture environmental data from a perspective of the user. The wearable device includes electronic hardware structured to perform local data processing while moving in continuous spatial conjunction with the user.

As used herein, an imaging device may refer to an optical sensor configured to capture visual data from a surrounding environment, such as a camera, a depth sensor, or an infrared sensor on a wearable device or a mobile device. The imaging device may also be referred to herein as a first imaging device or a second imaging device. Geospatial data may refer to quantitative data values representing a geographical position and a directional orientation of a device, such as latitude coordinates, longitude coordinates, altitude, and compass heading values. Geospatial data provides the coarse framework for identifying the proximity of the device to known environmental features.

As used herein, a navigation action may refer to a technical signal, such as a spatial audio signal or a visual instruction, generated to provide directional guidance relative to an environmental feature. The navigation action represents a machine-generated output that modifies a state of an output device to guide a user. The navigation action may also be referred to herein as a first navigation action, a second navigation action, an action, or a direction for a route. An orientation may refer to a six-degree-of-freedom measurement representing the position and the directional heading of a device relative to an environment. The orientation may also be referred to herein as a first orientation, or a pose. An output device may refer to a hardware peripheral within a computing architecture configured to convert machine-generated spatial instructions into human-perceptible sensory feedback. An audio transducer may refer to an electroacoustic hardware element configured to translate synthesized electrical signals into directional sound waves, resulting in a simulation of an environment-anchored audio source.

As used herein, a navigation path may refer to a polyline sequence of coordinates or virtual anchors representing a route to a destination. The navigation path may also be referred to herein as a first navigation path or a second navigation path. A feature profile may refer to a digital signature, geometric model, or data structure representing a recognizable environmental feature within a geospatial datastore. The feature profile includes a multi-dimensional feature vector or a set of pixel-level descriptors that define a verifiable environmental anchor used to reconcile sensor measurements. The feature profile may also be referred to herein as a first feature profile or a second feature profile. A set of candidate features may refer to a preliminary collection of feature profiles representing static landmarks retrieved from a geospatial datastore. The set of candidate features includes feature profiles selected based on a localized geographic radius of a position of an imaging device. The set of candidate features provides a technical search-space for a correspondence analysis, resulting in a reduction of computational latency during a feature identification process.

As used herein, a target heading may refer to a directional vector representing a required orientation for a device to remain aligned with the navigation path. The target heading serves as a technical baseline for calculating an angular deviation. A correspondence may refer to a result of a matching operation, such as a similarity score or a probability distribution, that represents a degree of alignment between captured image data and a feature profile. The correspondence establishes a verifiable presence of a feature within the image data, resulting in a geometric calibration of a device orientation.

As used herein, a virtual anchor may refer to a digital coordinate marker established relative to a geospatial position and projected into a coordinate system to serve as a reference point for navigation or spatial audio placement. A proximity threshold may refer to a defined spatial boundary or a quantitative distance value evaluated against a calculated geographic position. The proximity threshold defines a mathematical limit that, when satisfied by a physical position of a wearable device, initiates a logical state change within a mobile navigation architecture. The proximity threshold may be adaptively scaled based on an uncertainty radius of geospatial data. A confidence metric may refer to a quantitative value representing a statistical reliability of a match between captured data and a reference profile. The confidence metric may be determined based on a probability distribution, a cross-entropy loss function, or a cosine similarity measurement.

As used herein, an attribute may refer to a metadata property of an environmental feature, such as a permanence of the environmental feature. The permanence represents a permanence score assigned to the environmental feature within the feature profile. The permanence score includes a quantitative value representing a temporal stability or a static nature of the environmental feature within a physical environment over a defined duration. The feature analysis module 320 incorporates the permanence score into the calculation of the confidence metric, where a higher permanence score results in a higher statistical weight during the ranking of the plurality of feature profiles. A sequence of instructions may refer to an ordered set of navigation actions provided in a specific temporal or spatial succession. Enrollment data may refer to a set of configuration parameters, user preferences, or system instructions that define a functional state of a processing system.

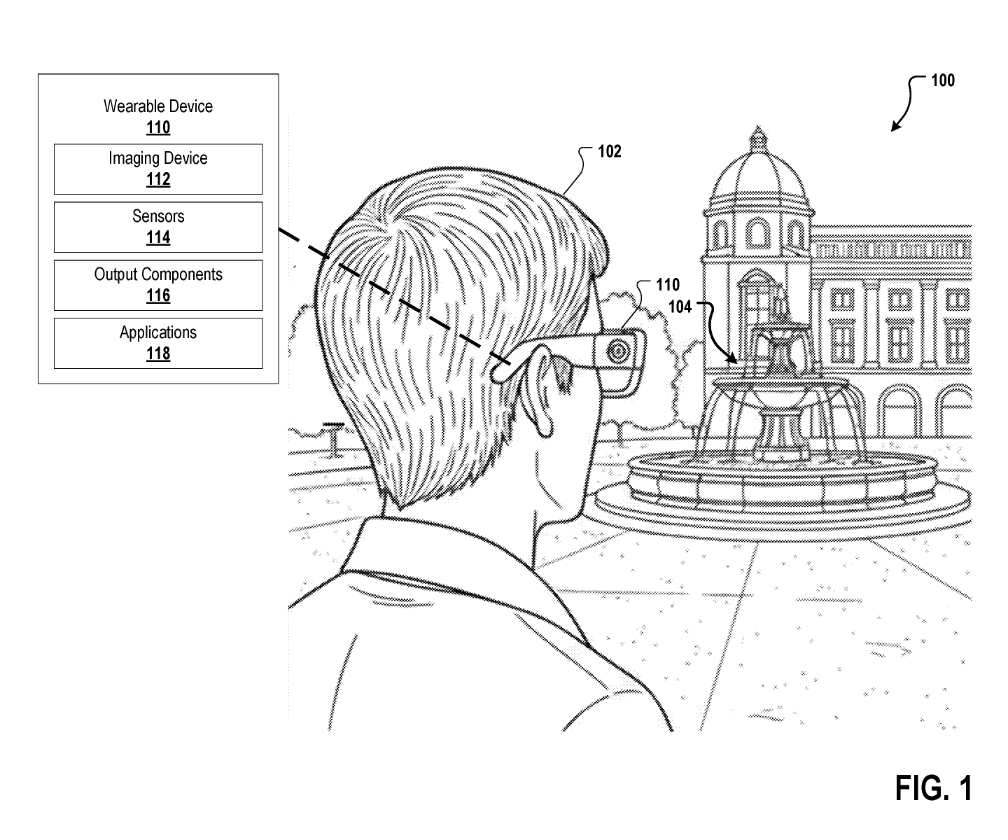

FIG. 1 illustrates an example environment 100 in which aspects of the disclosure are implemented. The environment 100 depicts a geographic area, such as a city street or an urban canyon, where a user 102 is navigating. The user 102 wears a wearable device 110, depicted as a pair of smart glasses. The environment 100 further illustrates a feature 104, shown as a landmark such as a fountain, a storefront, or a piece of infrastructure. The feature 104 represents an environmental anchor for the navigation.

Where a user 102 provides consent for the collection of data, the wearable device 110 captures image data of the surroundings via an imaging device 112 and geospatial data via a set of sensors 114. The set of sensors 114 includes hardware for determining a global position and a local orientation, such as a global positioning system (GPS) receiver and an inertial measurement unit (IMU). A high-level block diagram of the wearable device 110 is also shown, illustrating components that operate to generate contextual navigation instructions and spatial audio signals via output components 116.

The wearable device 110 captures the image data and the geospatial data simultaneously to facilitate a temporal alignment between visual context and positional measurements. The wearable device 110 employs the imaging device 112 to identify verifiable environmental anchors within the environment 100. Identifying the verifiable environmental anchors results in a navigation experience anchored to the feature 104.

The wearable device 110 functions as a source of environmental data and orientation data. Applications 118 running on the wearable device 110 request access to the image data and the geospatial data, resulting in the provision of navigation actions for the user 102.

The wearable device 110, or a system in communication with the wearable device 110, employs a vision language model to analyze the image data. The vision language model identifies the feature 104 within the image data and generates an egocentric instruction relative to the feature 104. The identification of the feature 104 results in a geometric calibration of a pose of the wearable device 110.

The pose includes a six-degree-of-freedom (6DOF) measurement representing the position and the orientation of the imaging device 112 relative to the environment 100. The 6DOF measurement includes Cartesian coordinates representing the position and angular orientation values representing the orientation. The analysis of the image data results in a link between a navigation path and the environment 100, establishing an egocentric navigation experience.

The egocentric instruction provides directional guidance based on the current perspective of the user 102. For example, the vision language model provides an egocentric instruction to turn left when the feature 104 is positioned on a right side of a field of view of the imaging device 112.

The vision language model performs a correspondence analysis between the captured image data and feature profiles retrieved from a geospatial datastore. The feature profiles include two-dimensional or three-dimensional descriptors of verifiable environmental features. By matching the image data to the feature profiles, the vision language model determines a precise alignment between the wearable device 110 and the feature 104. The alignment allows the wearable device 110 to convert cardinal directions, such as north or west, into egocentric directions, such as left or right, based on the current heading of the user 102.

The geometric calibration provides a technological solution to the problem of signal degradation by ensuring that the navigation action remains accurate even in areas where the geospatial data from the set of sensors 114 exhibits signal-intensive interference or reduced precision. The vision language model prioritizes the feature 104 based on a proximity threshold, selecting a feature 104 that is closer to the user 102, resulting in an instruction related to the feature 104 that is verifiable by the user 102. The correspondence analysis employs a probability distribution to assign a confidence metric to the identification of the feature 104, resulting in the wearable device 110 providing the navigation action only when the confidence metric exceeds a reliability threshold.

The wearable device 110 constitutes a computing apparatus operated by the user 102. In some implementations, the systems and methods can be implemented on any suitable computing device, including augmented reality (AR) headsets, extended reality (XR) headsets, or mobile devices. The wearable device 110 captures, processes, and transmits information related to the environment 100 and the orientation of the user 102. The wearable device 110 includes a frame housing the components and a power source, such as a battery.

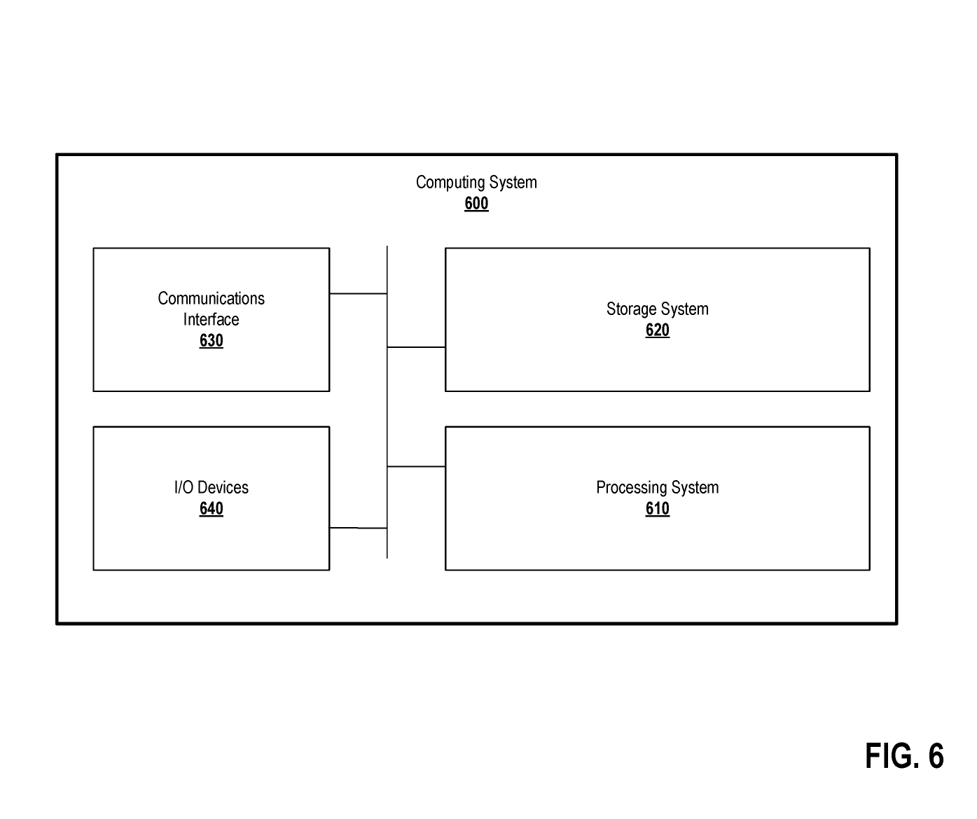

The wearable device 110 includes a combination of hardware components and software components. As described in greater detail with reference to FIG. 6, hardware and software elements include one or more imaging devices 112, a set of sensors 114, output components 116, and a plurality of applications 118. The set of sensors 114 may include, for example, a global positioning system (GPS) receiver, an inertial measurement unit (IMU), or a magnetometer used in the determination of the geospatial data. The output components 116 provide information to the user 102 and may include a display, an audio transducer, or a combination of a display and an audio transducer. The output components 116 generate the navigation action via spatial audio signals, visual instructions, or both. The output components 116 are further configured to maintain a suppression state to minimize interference for the user 102. The applications 118 include a navigation application that requests the image data and the geospatial data of the wearable device 110 via an application programming interface (API).

The output components 116 employ spatial audio synthesis to provide directional guidance. The spatial audio synthesis simulates how a sound signal reaches the ears of the user 102 by applying Head-Related Transfer Functions (HRTF). The HRTF processing accounts for the relative spatial position of an audio source and applies signal processing based on human ear topology. The signal processing includes applying frequency-dependent attenuation and temporal delays to simulate the acoustic effects of the head and the outer ears of the user 102. The resulting audio signal allows the user 102 to perceive the audio source as originating from a specific point in a three-dimensional space, such as a position corresponding to a virtual waypoint marker on a navigation path. The wearable device 110 employs the audio transducer within the output components 116 to deliver the spatialized audio signal, creating a head-locked auditory reference for the navigation path.

The wearable device 110 maintains the suppression state of the output components 116 when the orientation of the wearable device 110 aligns with the navigation path. The suppression state ensures that the user 102 receives the navigation action only upon a determination that the orientation has deviated from a target heading. Maintaining the suppression state results in reduced audio interference and minimizes the cognitive load required for the user 102 to process the directional guidance. The maintenance of the suppression state further provides an optimization of battery performance by gating the power consumption of the audio transducer based on the alignment with the navigation path.

The imaging device 112 includes an optical sensor configured to capture a field of view of the user 102. Where a user 102 provides consent for the collection of image data and geospatial data, the imaging device 112 captures the surroundings of the user 102. In some implementations, the applications 118 receive the image data and determine an orientation of the imaging device 112 relative to the feature 104. The determination ensures that the navigation action contains a technical signal provided by the output components 116 and linked to the specific orientation of the wearable device 110.

The system described herein operates within a privacy-centric framework. The imaging device 112 captures the image data only upon the activation of a specific trigger. The trigger includes a determination that the wearable device 110 has satisfied a proximity threshold of a virtual anchor on the navigation path or a receipt of an explicit user request for orientation. To resolve the inherent inaccuracy of the sensors 114 prior to visual calibration, the computing system defines the proximity threshold based on an uncertainty radius of the geospatial data. In response to a determination that the uncertainty radius of a current GPS coordinate overlaps with the proximity threshold of a virtual anchor, the computing system initiates a coarse-to-fine transition. The coarse-to-fine transition causes a processing system to trigger a discrete image capture event. The event-based capture allows the vision language model to resolve the sensor-drift of the sensors 114 by identifying the feature 104, resulting in a transition from a coarse geospatial position to a calibrated 6DOF pose.

The environment 100 is not limited to a pedestrian setting or a smart glasses implementation. In some cases, the wearable device 110 may be integrated into a helmet, a head-mounted display, or an autonomous transport unit. The systems and methods described herein generate egocentric instructions for navigation within various landscapes. Analyzing the field of view and the environmental context results in a distinction between an instruction based on a distance and an instruction related to a feature, where the feature includes a landmark or another verifiable environmental anchor. The distinction results in a navigation experience that employs the feature for directional guidance.

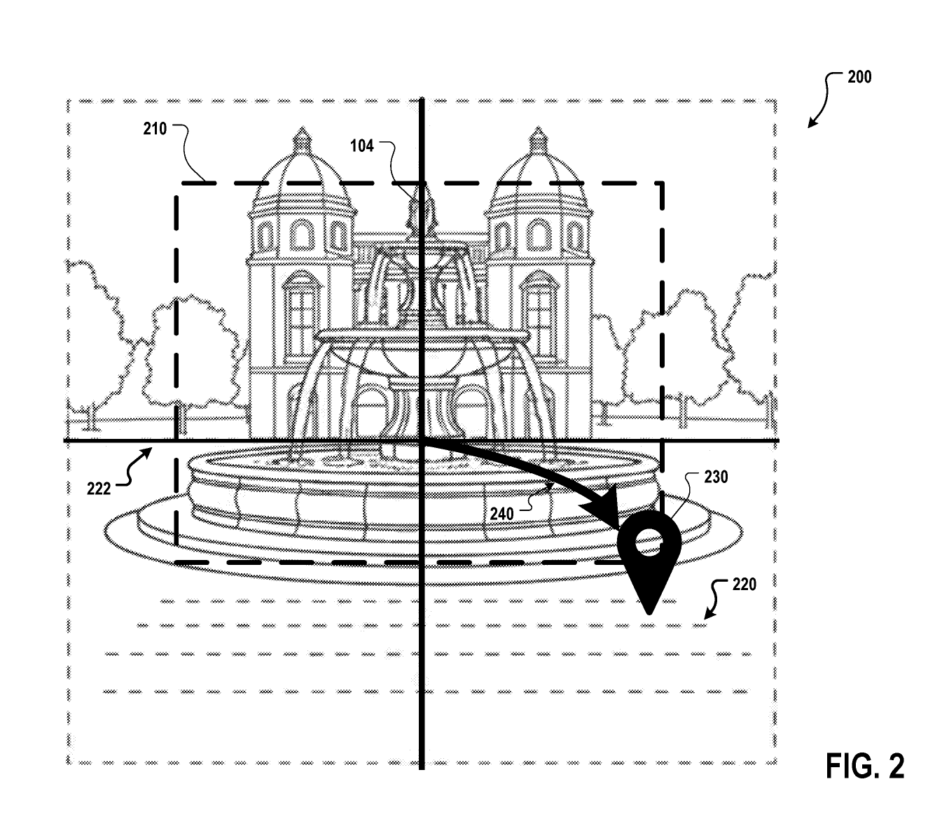

FIG. 2 represents a perspective of the imaging device 112 within the environment 100. The perspective includes a field of view 200 representing image data. A coordinate system 222 is established over the field of view 200 and is aligned with the geospatial data captured by the sensors 114. Within the field of view 200, a plurality of boundaries 210 identifies a feature 104, where the plurality of boundaries 210 includes a bounding box positioned around the feature 104. The coordinate system 222 includes a vertical axis and a horizontal axis. A plurality of horizontal markers 220 positioned on a ground surface within the field of view 200 represents egocentric distance markers. A virtual waypoint marker 230 is positioned at a base of the feature 104 to define a target heading for a navigation path. An orientation arrow 240 originates from a center of the field of view 200 and extends toward the virtual waypoint marker 230.

The coordinate system 222 provides a geometric framework for the transformation of pixel coordinates within the field of view 200 into spatial measurements. The orientation computation module 330 analyzes the position of the plurality of boundaries 210 relative to the vertical axis and the horizontal axis of the coordinate system 222. The analysis results in a determination of the angular relationship between the imaging device 112 and the feature 104. The plurality of horizontal markers 220 provide depth cues that the system employs to estimate a distance to the feature 104. By projecting the virtual waypoint marker 230 into the field of view 200, the system creates a visual representation of the navigation path that the user 102 may follow. The orientation arrow 240 indicates the required rotation of the wearable device 110 to achieve alignment with the target heading. The perspective and the coordinate system 222 illustrated in FIG. 2 provide the visual data used during the initialization process and the navigation action generation.

The perspective includes a plurality of horizontal markers 220 positioned on a ground surface within the field of view 200. The plurality of horizontal markers 220 represents egocentric distance markers that indicate a spatial relationship between the wearable device 110 and the feature 104. A coordinate system 222 is established over the image data within the field of view 200. The coordinate system 222 includes a vertical axis and a horizontal axis used to analyze a position of the plurality of boundaries 210 relative to the wearable device 110. The coordinate system 222 is illustrated with prominent lines in FIG. 2 for illustrative purposes. A visual display provided to the user 102 may employ a coordinate system that is visually subtle relative to the coordinate system 222 shown in FIG. 2, the visually subtle coordinate system resulting in reduced visual occlusion of the environment 100.

A virtual waypoint marker 230 is positioned within the field of view 200 at a base of the feature 104. The virtual waypoint marker 230 defines a target heading for a navigation path. The navigation path includes the plurality of horizontal markers 220 and the virtual waypoint marker 230. An orientation arrow 240 originates from a center of the field of view 200 and extends toward the virtual waypoint marker 230. The orientation arrow 240 represents the target heading used to guide the user 102.

The perspective of the imaging device 112 facilitates a measurement of a relationship between the plurality of boundaries 210 and the wearable device 110. A comparison of the position of the plurality of boundaries 210 relative to the axes of the coordinate system 222 results in a difference between an orientation of the imaging device 112 and the target heading represented by the orientation arrow 240. The spatial relationship between the plurality of horizontal markers 220 and the coordinate system 222 further results in an egocentric distance measurement relative to the feature 104. The perspective and the coordinate system 222 illustrated in FIG. 2 provide the visual data used during the initialization process and the navigation action generation.

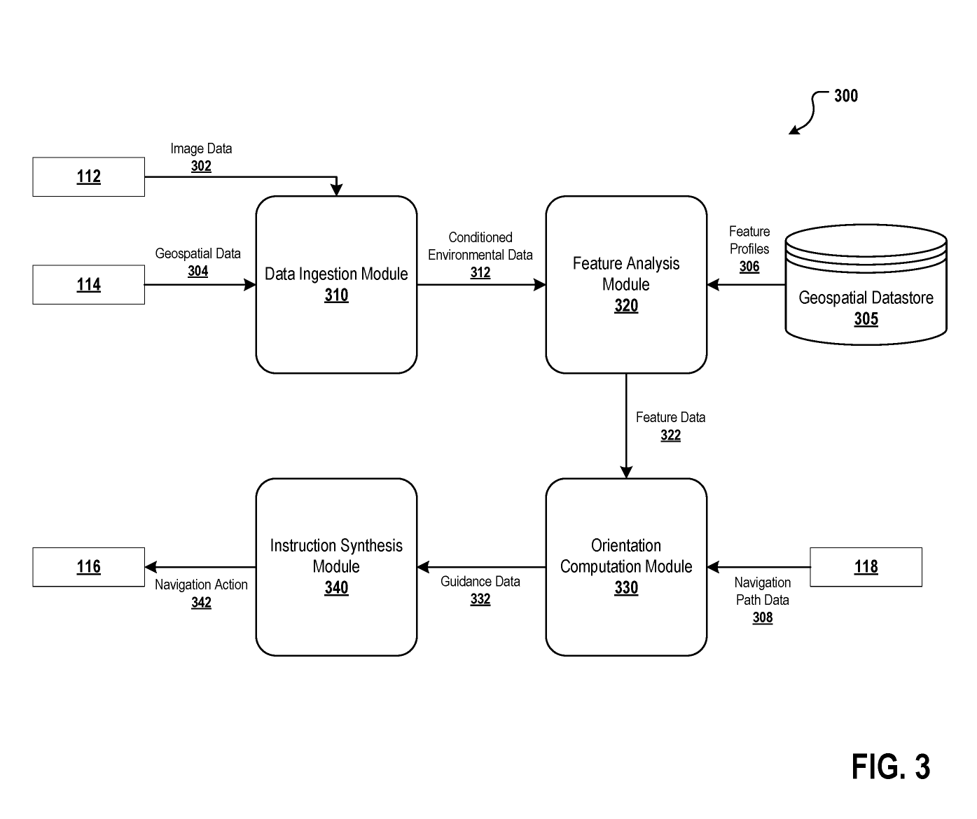

FIG. 3 is a block diagram illustrating a functional system architecture 300 for generating contextual navigation instructions. The functional system architecture 300 includes a set of logical modules configured to receive input data and provide at least one output based on the input data. Specifically, the functional system architecture 300 includes a data ingestion module 310, a feature analysis module 320, an orientation computation module 330, and an instruction synthesis module 340.

The data ingestion module 310 receives the image data 302 from the imaging device 112 and the geospatial data 304 from the sensors 114. The sensors 114 provide the geospatial data 304 by performing measurements of global positioning signals and magnetic field orientations. The data ingestion module 310 performs a conditioning of the image data 302 and the geospatial data 304. The conditioning includes synchronizing a plurality of timestamped frames from the imaging device 112 with a plurality of positional coordinates and heading values from the sensors 114. For example, the data ingestion module 310 synchronizes image frames captured at a frequency of 30 Hertz with inertial measurement unit data captured at a frequency of 100 Hertz.

The data ingestion module 310 performs a temporal alignment and interpolation to ensure that each frame of the image data 302 corresponds to a specific geospatial measurement. The conditioning further includes performing noise reduction, bit-depth normalization, and color-space conversion on the image data 302 to optimize the image data 302 for neural network inference. The conditioning results in the conditioned environmental data 312 provided to the feature analysis module 320. The conditioned environmental data 312 allows the feature analysis module 320 to initiate a localized search for feature profiles 306 within a defined geographic radius of the wearable device 110, where the localized search results in a reduction of search-space latency and an increase in identification accuracy.

The feature analysis module 320 receives the conditioned environmental data 312 from the data ingestion module 310 and the feature profiles 306 from the geospatial datastore 305. The feature profiles 306 include two-dimensional or three-dimensional descriptors of verifiable environmental anchors, such as geometric models, edge-maps, or visual signatures of static landmarks. The feature analysis module 320 employs a Vision Language Model (VLM) to perform an analysis of the conditioned environmental data 312. The feature extraction process includes the feature analysis module 320 extracting visual features from the image data 302, such as pixel-intensity gradients, spatial frequency distributions, and geometric boundary descriptors.

The feature analysis module 320 feeds the visual features into the VLM, which includes a trained neural network, to produce a correspondence output between the image data 302 and the feature profiles 306. The VLM is initialized with a set of pre-trained weights derived from a large-scale dataset of environmental imagery before the VLM performs localized inference. The VLM executes neural network inference by passing the visual features through a series of convolutional layers or transformer-based attention blocks to extract a multidimensional feature vector.

The feature analysis module 320 calculates a similarity score between the multidimensional feature vector and the feature profiles 306 using a cosine similarity function. The feature analysis module 320 evaluates the analysis of the feature 104 using a plurality of metrics, such as a mean average precision (mAP) of bounding box detections and a pixel-level reprojection error. The feature analysis module 320 assigns a confidence metric to the identified feature 104 based on the similarity score. The feature analysis module 320 performs a ranking of the plurality of feature profiles 306 relative to the confidence metric. The ranking of the plurality of feature profiles 306 enables the feature analysis module 320 to differentiate between multiple candidate features, resulting in the selection of a feature 104 with a highest statistical reliability.

The feature analysis module 320 employs an object detection head to predict bounding box coordinates around candidates for the feature 104. The feature analysis module 320 analyzes the position of the bounding box relative to a horizontal x-axis of a field of view of the imaging device 112 to determine if the feature 104 is positioned on a left side or a right side of the imaging device 112. The analysis of the content includes the determination of environmental key points, visual textures, and structural boundaries that match a verified landmark in the feature profiles 306.

The feature analysis module 320 determines the presence of the feature 104 and establishes the coordinate system 222, resulting in the feature data 322 provided to the orientation computation module 330. The feature analysis module 320 employs the coordinate system 222 as a geometric framework to analyze the position of the feature 104. The analysis of the position results in an angular offset calculation between the feature 104 and a central optical axis of the imaging device 112. The angular offset calculation includes a determination of pixel-coordinates relative to the vertical axis and horizontal axis of the coordinate system 222. The feature analysis module 320 further determines the distance value by performing a geometric projection of the plurality of boundaries 210. The feature analysis module 320 retrieves a known physical dimension of the environmental feature from the feature profile 306 and calculates a ratio between a pixel-width of the plurality of boundaries 210 and the known physical dimension. By applying a focal length and a principal point offset from a camera intrinsics matrix of the imaging device 112, the feature analysis module 320 transforms the ratio into a quantifiable distance measurement. The feature analysis module 320 further refines the distance measurement by mapping the pixel-coordinates of the horizontal markers 220 to a ground-plane model using a trigonometric projection, resulting in a depth cue that validates the distance measurement.

The orientation computation module 330 receives the feature data 322 along with the navigation path data 308 from the applications 118. The orientation computation module 330 determines an orientation of the imaging device 112 and calculates a difference between the orientation and a target heading of the navigation path data 308. The orientation computation module 330 determines a 6DOF measurement representing the position and the orientation of the imaging device 112 relative to the environment 100. The 6DOF measurement includes Cartesian coordinates (x, y, z) representing the position and angular orientation values (pitch, yaw, roll) representing the orientation.

The orientation computation module 330 performs a reconciliation of the feature data 322 with the geospatial data 304, resulting in a calibration of the 6DOF measurement. The reconciliation includes transforming the local coordinates of the feature 104 from the image plane into a global coordinate framework. The orientation computation module 330 compares the visual perspective of the feature 104 with a predicted perspective derived from the geospatial datastore 305, resulting in a resolution of sensor drift in the sensors 114. The reconciliation results in the guidance data 332. The orientation computation module 330 provides the guidance data 332 to the instruction synthesis module 340, resulting in a conversion of the 6DOF measurement and the guidance data 332 into user-perceptible feedback. In some implementations, the orientation computation module 330 performs an analysis of movement without determining the movements of the user 102 between navigation events.

The instruction synthesis module 340 receives the guidance data 332 to generate a navigation action 342. The instruction synthesis module 340 provides the navigation action 342 to the output components 116. The instruction synthesis module 340 is further configured to maintain a suppression state of the output components 116 based on the guidance data 332. The instruction synthesis module 340 employs spatial audio synthesis to provide directional guidance. The spatial audio synthesis simulates how a sound signal reaches the ears of the user 102 by applying a HRTF. The instruction synthesis module 340 performs a technical analysis of the guidance data 332 to extract orientation features, such as angular deviation values and relative elevation angles.

The instruction synthesis module 340 feeds the orientation features into a trained classification model to select a pair of HRTF filters from an HRTF library. The HRTF is initialized with a rules-based system of universal head and pinna measurements before the instruction synthesis module 340 adapts the HRTF filters based on enrollment data. The instruction synthesis module 340 performs a real-time convolution of a monaural audio signal with the pair of HRTF filters. The HRTF filters apply specific spectral notches and peaks to the monaural audio signal to simulate the acoustic effects of the pinna, the head, and the torso, resulting in a spatially encoded audio stream.

The instruction synthesis module 340 evaluates the effectiveness of the spatial audio synthesis using metrics such as an angular localization error and a signal-to-noise ratio. The signal processing includes applying interaural time differences (ITD) by delaying the monaural audio signal to one ear relative to the other ear, and interaural level differences (ILD) by applying frequency-dependent attenuation. The resulting spatial audio signal allows the user 102 to perceive a sound source, such as the virtual waypoint marker 230, as originating from a specific spatial coordinate. The maintenance of the suppression state ensures that the user 102 receives the navigation action 342 only upon a determination that the orientation has deviated from a target heading. The maintenance of the suppression state results in a reduction of auditory interference and an optimization of battery consumption for the wearable device 110.

The orientation computation module 330 performs the orientation determination by comparing a perspective of the imaging device 112 to the geospatial data 304. The comparison involves the use of a Visual Positioning System (VPS) that matches environment key points in the image data 302 to verified features in the geospatial datastore 305. The VPS calibration allows the orientation computation module 330 to calculate the 6DOF measurement with increased precision compared to the sensors 114 alone.

The instruction synthesis module 340 employs the resulting orientation to generate the spatial audio signal. The spatial audio signal is modulated based on the guidance data 332 to provide an auditory representation of the directional difference. For example, the instruction synthesis module 340 increases an amplitude, changes a frequency, or modulates a pulse-rate of the spatial audio signal as the difference between the orientation and the target heading increases. The modulation provides a continuous feedback loop that guides the user 102 toward the correct direction of travel by mapping the magnitude of the angular error to a perceptible change in the audio signal. The modulation results in an intuitive corrective signal that requires low cognitive load from the user 102.

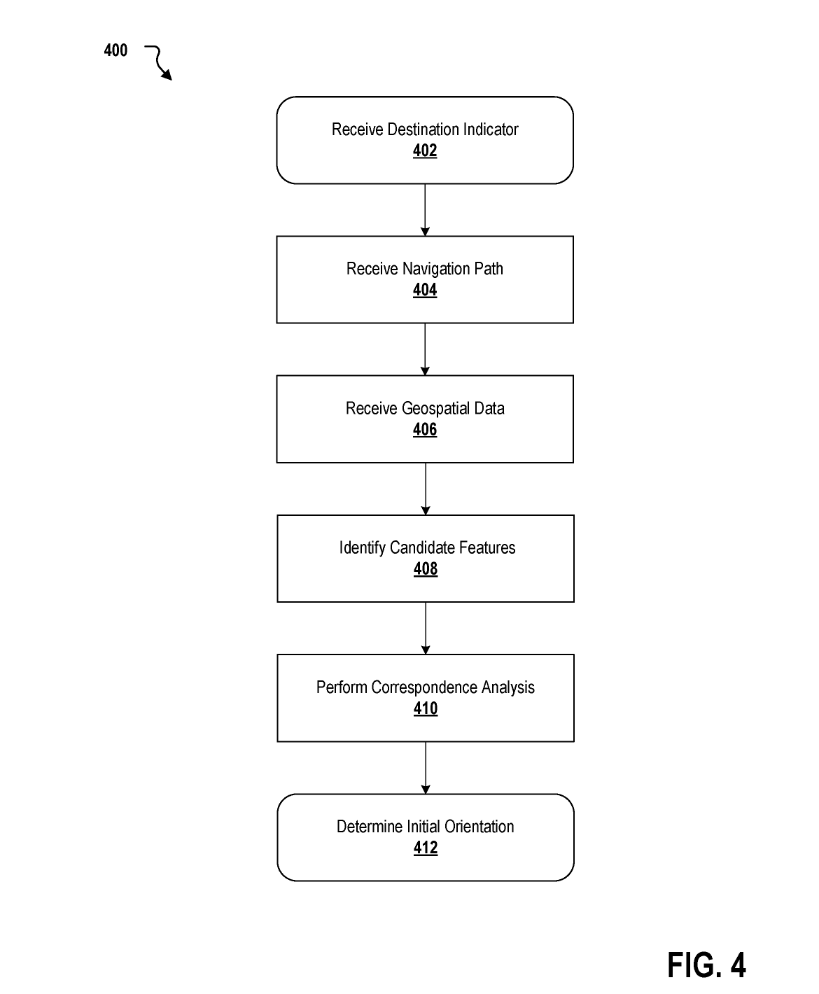

FIG. 4 is a flowchart illustrating an example process 400 for initializing a navigation path. The process 400 establishes a technical relationship between the wearable device 110 and the environment 100 as a prerequisite for the functional system architecture 300 providing the navigation action 342. The process 400 defines the spatial framework used by the modules during subsequent movement.

At step 402, the navigation application 118 receives an indicator of a destination from the user 102. The receipt of the indicator results in an activation of a routing request. From step 402, the process 400 proceeds to step 404.

At step 404, the navigation application 118 receives the navigation path from a directions service. The navigation path includes a plurality of virtual anchors and the navigation path data 308 representing a route to the destination. The navigation path data 308 includes a polyline sequence of geospatial coordinates and metadata representing required maneuvers. The navigation application 118 parses the polyline sequence to identify the geospatial coordinates of the virtual waypoint marker 230 associated with the next turn on the route. The receipt of the navigation path results in the population of a routing buffer in the storage system 620. From step 404, the process 400 proceeds to step 406.

At step 406, the data ingestion module 310 receives the geospatial data 304 from the sensors 114. The data ingestion module 310 performs a conditioning of the geospatial data 304, resulting in a coarse location measurement of the wearable device 110. From step 406, the process 400 proceeds to step 408.

At step 408, the feature analysis module 320 identifies a set of candidate features from the geospatial datastore 305. The feature analysis module 320 performs a localized search of the geospatial datastore 305 based on the coarse location measurement to retrieve the feature profiles 306. From step 408, the process 400 proceeds to step 410.

At step 410, the feature analysis module 320 performs a correspondence analysis between the image data 302 and the feature profiles 306. The feature analysis module 320 employs the Vision Language Model (VLM) to identify the feature 104 within a field of view of the imaging device 112. The correspondence analysis includes matching visual descriptors, such as Scale-Invariant Feature Transform (SIFT) or oriented features from accelerated segment test (FAST) and rotated binary robust independent elementary features (BRIEF) (ORB) descriptors, from the image data 302 to known environmental key points within the feature profiles 306. The feature analysis module 320 calculates a confidence metric for the match between the image data 302 and the feature profiles 306 using a cross-entropy loss function or a cosine similarity measurement. The feature analysis module 320 performs a ranking of the plurality of feature profiles 306 based on the confidence metric. The feature analysis module 320 selects the feature 104 from the set of candidate features based on the ranking, ensuring that the identified feature 104 is an environmental feature with temporal stability suitable for spatial calibration. The selection of the feature 104 results in the generation of the feature data 322. From step 410, the process 400 proceeds to step 412.

At step 412, the orientation computation module 330 determines an initial orientation of the imaging device 112. The orientation computation module 330 establishes the 6DOF pose of the wearable device 110 by reconciling the feature data 322 with the geospatial data 304. The orientation computation module 330 employs a Perspective-n-Point (PnP) algorithm to solve for the translation vector and rotation matrix that minimizes the reprojection error between the identified key points in the image data 302 and the 3D coordinates in the feature profiles 306. The reconciliation includes the calculation of a 4x4 homogeneous transformation matrix to align a local coordinate frame of the wearable device 110 with a global coordinate frame of the geospatial datastore 305.

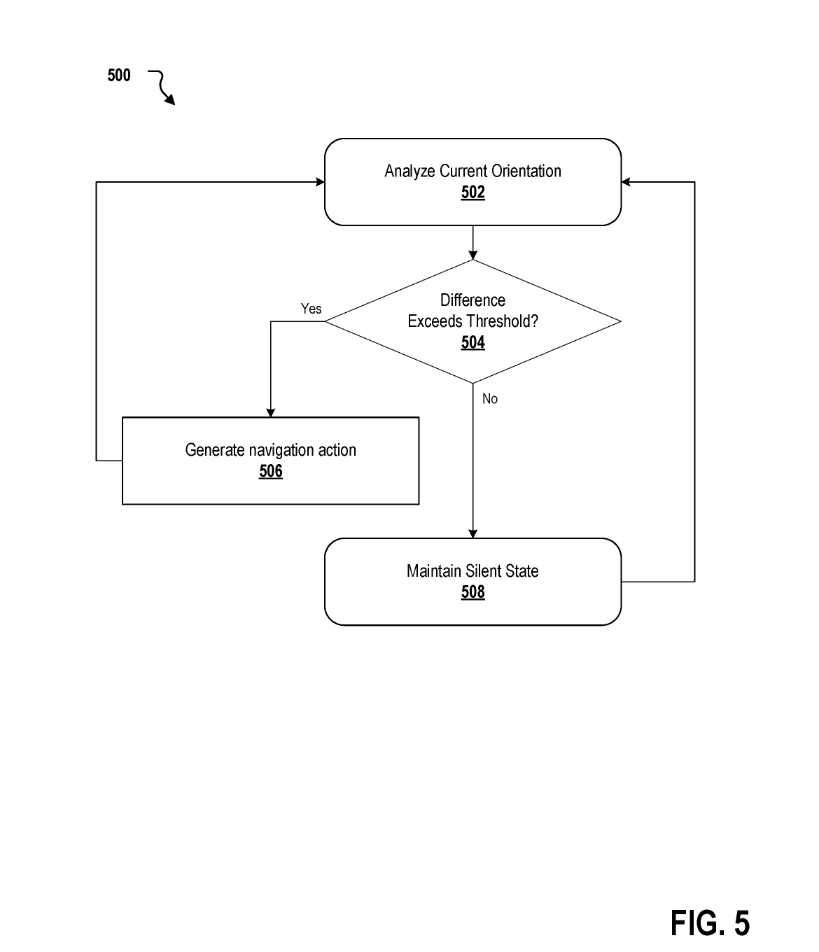

The orientation computation module 330 verifies the 6DOF pose by performing a reprojection of the feature profiles 306 into the image plane using a camera intrinsics matrix and comparing the predicted pixel coordinates with the observed pixel coordinates of the feature 104. The establishment of the 6DOF pose results in a spatial calibration of the wearable device 110 relative to the environment 100. The spatial calibration provides a technical baseline for the real-time corrective logic flow described in FIG. 5. From step 412, the process 400 ends or repeats.

FIG. 5 is a flowchart illustrating an example process 500 for providing the navigation action 342. The process 500 represents the real-time corrective logic flow used to maintain an alignment between the wearable device 110 and the navigation path.

At step 502, the orientation computation module 330 analyzes the current orientation of the imaging device 112. The analysis includes a reconciliation of the geospatial data 304 and the feature data 322 to determine a precise directional heading. The orientation computation module 330 updates the 6DOF pose at a defined sampling frequency to account for user movement. From step 502, the process 500 proceeds to step 504.

At step 504, the orientation computation module 330 determines if a difference between the current orientation and the target heading exceeds the threshold. The orientation computation module 330 retrieves the virtual waypoint marker 230 from the navigation path data 308. The orientation computation module 330 calculates a vector dot product between the current heading vector of the imaging device 112 and a directional vector pointing from the wearable device 110 toward the virtual waypoint marker 230. The orientation computation module 330 employs the arc-cosine of the dot product to determine an angular deviation in degrees. The threshold includes a predetermined or adaptive angular value, such as fifteen degrees, that defines the boundary for a corrective navigation action 342. If the orientation computation module 330 determines that the angular deviation exceeds the threshold, the process 500 proceeds to step 506. If the orientation computation module 330 determines that the angular deviation does not exceed the threshold, the process 500 proceeds to step 508. The comparison ensures that the navigation action 342 is generated only when the wearable device 110 is misaligned with the navigation path, resulting in reduced cognitive distraction for the user 102.

At step 506, the instruction synthesis module 340 generates the navigation action 342. The navigation action 342 includes the spatial audio signal provided via the output components 116. The instruction synthesis module 340 modulates the frequency, the amplitude, or the spatial panning of the spatial audio signal based on a magnitude of the angular deviation determined during step 504. For example, the instruction synthesis module 340 may increase the amplitude of the spatial audio signal as the angular deviation increases, providing a technical indicator of the requirement for rotation. The instruction synthesis module 340 may also apply a pitch-shift to the audio signal to indicate whether the user 102 should rotate to the left or to the right. The generation of the navigation action 342 results in a trigger signal that directs the user 102 to rotate the wearable device 110 toward the target heading. From step 506, the process 500 proceeds back to step 502.

At step 508, the instruction synthesis module 340 maintains the suppression state of the output components 116. The maintenance of the suppression state includes gating the audio signal to prevent delivery to the user 102. The maintenance of the suppression state ensures that the navigation action 342 is provided only upon a determination that the angular deviation exceeds the threshold. The suppression state results in reduced audio interference and an optimization of cognitive load for the user 102. While the instruction synthesis module 340 maintains the suppression state, the orientation computation module 330 continues to analyze the orientation of the imaging device 112 to detect any subsequent deviation from the target heading. From step 508, the process 500 proceeds back to step 502 or ends.

FIG. 6 illustrates an example computing system 600 employed to implement aspects of the disclosure. As depicted in FIG. 6, the computing system 600 includes a processing system 610, a storage system 620, a communication interface 630, and one or more input/output (I/O) devices 640. The processing system 610 operatively links to the communication interface 630, the one or more I/O devices 640, and the storage system 620. The computing system 600 further includes other components, such as a power source and an enclosure. In wearable implementations such as the wearable device 110, a battery serves as the power source, making the wearable device 110 a battery-powered device. The computing system 600 represents the technical infrastructure for the functional system architecture 300.

The processing system 610 includes circuitry that retrieves and executes operating software from the storage system 620. The processing system 610 includes a System-on-Chip (SoC) that integrates multiple processing components. The processing components include one or more Central Processing Units (CPUs) that function as general-purpose processor cores for an operating system and application logic. The processing system 610 also includes specialized hardware logic, such as specialized instructions within the processing system 610 designed for vision language model operations. The specialized hardware logic executes sensor data analysis with a specific allocation of processor cycles and power consumption. For example, specialized instructions within the processing system 610 on the wearable device 110 accelerate execution of the feature analysis described above, which is advantageous for reducing the latency of the orientation determination on a local device.

The one or more I/O devices 640 include peripherals that allow a user 102 to interact with the computing system 600 or that allow the computing system 600 to receive input from an environment 100. In implementations where the computing system 600 represents the wearable device 110, the I/O devices 640 include the imaging device 112, the sensors 114 described in FIG. 1, and the output components 116. The communication interface 630 enables the computing system 600 to communicate with other devices over a network. The communication interface 630 transmits the image data 302 to a remote server for pixel-dense analysis or receives the navigation path data 308 from a cloud-based service. The local processing on the wearable device 110 maintains the orientation determination during periods of network latency, while the remote server performs the pixel-dense analysis using the image data 302.

The storage system 620 includes volatile and nonvolatile, removable, and non-removable media using any method or technology for storage of information, such as computer-readable instructions, data structures, program modules, or other data. Implementations of the storage system 620 employ a single storage device or multiple storage devices or sub-systems. Examples of storage media include random access memory (RAM), read-only memory (ROM), and flash memory. The storage media are non-transitory, such as a non-transitory computer-readable medium.

The storage system 620 stores operating software, which includes machine-readable program instructions. The storage system 620 further stores enrollment data, which includes user-specific configurations and system instructions for the vision language model. When the processing system 610 loads and executes the instructions from the storage system 620, the instructions configure the processing system 610 to operate as a special-purpose machine. The resulting configuration causes the computing system 600 to perform the specific steps and functions described throughout the disclosure. For example, when the computing system 600 is implemented as the wearable device 110, the storage system 620 stores the applications 118, the enrollment data, and the logic associated with the functional system architecture 300.

The storage system 620 stores instructions that, when executed by the processing system 610, cause the computing system 600 to perform the functions recited in the claims. The execution of the instructions is a concrete, physical process that transforms the general-purpose processing system 610 into a special-purpose machine configured to perform the described methods. For example, the execution of an instruction sequence involves fetching the instructions from the storage system 620 into a register of the processing system 610. A control unit of the processing system 610 decodes the instructions and, in response, generates control signals that direct other hardware components, such as an arithmetic logic unit (ALU), to perform specific operations on the guidance data 332.

The sequential execution of the instructions physically manipulates the circuitry of the processing system 610, causing the hardware to reorganize data paths between the System-on-Chip (SoC) and the sensors 114. The processing system 610 configures specific registers and the ALU to perform the vector dot product operations required to calculate the angular deviation from a target heading.

The configuration of the specific registers and the ALU enables the computing system 600 to perform specialized functions, such as head-related transfer function (HRTF) convolution, which the general-purpose hardware cannot perform without such specific structural reorganization. The transformation results in a specialized navigation apparatus that operates with reduced computational overhead by gating the output components 116 based on a determined orientation state, thereby extending the operational battery life of the special-purpose machine.

The operating software includes instructions for causing the computing system 600 to perform the processes described herein. The operating software is organized into distinct modules that correspond to the logical modules of the functional system architecture 300. For example, the storage system 620 stores the data ingestion module 310, the feature analysis module 320, the orientation computation module 330, and the instruction synthesis module 340. The modules communicate with each other through application programming interfaces (APIs) that specify the formats for data exchange and the protocols for communication between the modules.

In various implementations, any collection, storage, or use of data by the computing system 600 occurs where a user 102 provides consent for such operations. In some implementations, the computing system 600 provides the user 102 with one or more user interfaces or tools that allow the user 102 to manage, review, or delete data. For example, the tools provide options to review, modify, or delete preferences or other data associated with a user account. A user 102 may explicitly grant or revoke permission for a specific application to access the imaging device 112 or geospatial data 304 via a device prompt. In some cases, the computing system 600 aggregates data to prevent associating the data with a particular user. The computing system 600 validates that orientation and navigation operations comply with such permissions. Furthermore, the computing system 600 manages security parameters to mitigate the risk of unauthorized access to the image data 302 by unauthorized entities.

Although certain drawings illustrate hardware and software located within particular devices, the hardware and software components are shown to facilitate an understanding of the disclosure. In some implementations, the system combines or divides the hardware and software components into separate software, firmware, or hardware. For example, a system employs multiple electronic processors to distribute logic and processing as an alternative to employing a single electronic processor to perform the logic and the processing. In implementations where processing occurs on a local device, the system maintains user privacy by performing data analysis without network transmission. In implementations where processing is distributed among different computing devices connected by one or more networks, the system leverages distributed computational resources for complex model execution. Regardless of the combination or the division, the hardware and the software components reside on a same computing device or are distributed among different computing devices connected by one or more networks or other suitable communication links.

Moreover, various implementations of the systems and techniques described herein can be implemented in digital electronic circuitry, integrated circuitry, specially designed hardware such as application-specific integrated circuits, computer hardware, firmware, software, or combinations thereof. The various implementations can include implementation in one or more computer programs that are executable or interpretable on a programmable system including at least one programmable processor, which may be special or general purpose, coupled to receive data and instructions from, and to provide data and instructions to, a storage system, at least one input device, and at least one output device.

Computer programs (also known as programs, software, software applications, or code) include computer readable or machine instructions for a programmable electronic processor and can be implemented in a high-level procedural or object-oriented programming language, or in assembly/machine language. As used herein, the terms “machine-readable medium” and “computer-readable medium” refer to any computer program product, apparatus or device (e.g., magnetic discs, optical disks, memory, Programmable Logic Devices (PLDs)) used to provide machine instructions or data to a programmable processor, including a machine-readable medium that receives machine instructions as a machine-readable signal. The term “machine-readable signal” refers to any signal used to provide machine instructions or data to a programmable processor.

A system may combine or distribute the functionality of the computer-readable instructions as desired in various environments. In some implementations, a computer program includes one sequence of instructions, while in other implementations, a computer program includes a plurality of sequences of instructions. A computer program may originate from one location or from a plurality of locations. In various implementations, a computer program includes one or more software modules. The computer program may also include, in part or in whole, one or more web applications, mobile applications, standalone applications, web browser plug-ins, extensions, add-ins, add-ons, or combinations thereof.

As used herein, the term “real-time” refers to a system or process configured to respond to an event or signal within a defined time constraint. A real-time system, such as the computing system 600 described for processing the image data 302 or providing the navigation action 342, operates with minimized latency to enable immediate decision-making. The latency is small enough to allow the computing system 600 to determine the orientation and return the navigation action 342 without degrading the performance of the wearable device 110. Unless otherwise defined, technical terms used herein have the same meaning as commonly understood by one of ordinary skill in the art to which the subject matter pertains. In the specification and the appended claims, the singular forms “a,” “an,” and “the” include plural references unless the context clearly dictates otherwise. Any reference to “or” herein encompasses “and/or” unless otherwise stated.

The preceding text describes a number of implementations. Various modifications, including the separation or integration of system components, may be made without departing from the spirit and scope of the disclosure. The disclosure also contemplates various alternatives to the described implementations, and the appended claims are intended to cover such variations and changes as fall within the spirit of the described subject matter.

What is claimed is:

1. A method comprising:
receiving image data from an imaging device and a plurality of feature profiles for a set of candidate features determined based on a position of the imaging device;
identifying a feature from the set of candidate features included in the image data based on a correspondence between the image data and a respective feature profile of the plurality of feature profiles;
determining an orientation of the imaging device by comparing a field of view of the image data to a location of the feature; and
providing, via an output device, an action determined based on the orientation and a navigation path.

2. The method of claim 1, further comprising:
determining a difference between the orientation and a target heading of the navigation path;
wherein the action is determined based on the difference.

3. The method of claim 1, further comprising:
identifying the set of candidate features based on the position of the imaging device and a proximity threshold.

4. The method of claim 1, further comprising:
assigning a distance value to the feature based on a plurality of boundaries of the feature within the image data;
wherein the action includes the distance value.

5. The method of claim 4, further comprising:
establishing a coordinate system based on the image data; wherein assigning the distance value includes determining a relationship between the feature and the imaging device by comparing a position of the plurality of boundaries relative to an axis of the coordinate system.

6. The method of claim 1, further comprising:
assigning a confidence metric to the feature, the confidence metric determined based on an attribute of the feature or a distance between the feature and the imaging device, wherein identifying the feature includes ranking the plurality of feature profiles relative to the confidence metric and selecting the feature from the set of candidate features based on the ranking.

7. The method of claim 6, wherein the attribute of the feature represents a permanence of the feature within an environment.

8. The method of claim 1, wherein the imaging device is a component of a wearable device, and the output device is an audio transducer that provides the action via an audio signal.

9. The method of claim 1, wherein the action includes a sequence of instructions associated with the navigation path.

10. The method of claim 9, wherein the sequence of instructions includes a turn direction and a reference to the feature in a sequential order.

11. The method of claim 1, wherein the output device includes a display, and the action is provided via the display.

12. A non-transitory computer-readable medium storing executable instructions that, when executed by an electronic processor, cause the electronic processor to:
receive image data from an imaging device and a plurality of feature profiles for a set of candidate features determined based on a position of the imaging device;
identify a feature from the set of candidate features included in the image data based on a correspondence between the image data and a respective feature profile of the plurality of feature profiles;
determine an orientation of the imaging device by comparing a field of view of the image data to a location of the feature; and
provide, via an output device, an action determined based on the orientation and a navigation path.

13. The non-transitory computer-readable medium of claim 12, wherein the executable instructions further cause the electronic processor to assign a confidence metric to the feature, the confidence metric determined based on an attribute of the feature or a distance between the feature and the imaging device.

14. The non-transitory computer-readable medium of claim 13, wherein the attribute of the feature represents a permanence of the feature within an environment.

15. The non-transitory computer-readable medium of claim 12, wherein the imaging device is a component of a wearable device, and the output device is an audio transducer that provides the action via an audio signal.

16. A system comprising:
an imaging device;
an electronic processor; and
a memory storing enrollment data and instructions that, when executed by the electronic processor, cause the system to:
receive image data from the imaging device and a plurality of feature profiles for a set of candidate features determined based on a position of the imaging device;
identify a feature from the set of candidate features included in the image data based on a correspondence between the image data and a respective feature profile of the plurality of feature profiles;
determine an orientation of the imaging device by comparing a field of view of the image data to a location of the feature; and
provide, via an output device, an action determined based on the orientation and a navigation path.

17. The system of claim 16, wherein the instructions further cause the system to determine a difference between the orientation and a target heading of the navigation path; wherein the action is determined based on the difference.

18. The system of claim 16, wherein the instructions further cause the system to assign a distance value to the feature based on a plurality of boundaries of the feature within the image data and the action includes the distance value.

19. The system of claim 16, wherein the action includes a sequence of instructions associated with the navigation path.

20. The system of claim 19, wherein the sequence of instructions includes a turn direction and a reference to the feature in a sequential order.
